(19) United States
(12) Patent Application Publication
(10) Pub. No.: US 2024/0157529 A1
(43) Pub. Date: May 16, 2024

(54) TOOL FOR SPRAY TIPS OF AGRICULTURAL SPRAYERS

(71) Applicant: Steve J. Olson, Enderlin, ND (US)

(72) Inventor: Steve J. Olson, Enderlin, ND (US)

(21) Appl. No.: 18/054,491

(22) Filed: Nov. 10, 2022

(51) Int. Cl. B25B 27/14; B05B 15/65

(52) U.S. Cl. CPC B25B 27/14; B05B 15/65

(57) ABSTRACT

A tool for agricultural sprayers having quick change nozzles includes an elongated member defined along an axis and a first pair of opposing slots to receive wings of an agricultural sprayer nozzle, the first pair of opposing slots defined within a plane that includes the axis. A method of changing a quick-change nozzle of an agricultural sprayer includes installing a tool having a pair of opposing slots onto a set of wings of a quick-change nozzle of an agricultural sprayer then rotating the tool by hand.

### BACKGROUND

The present disclosure relates to a tool, and more specifically to a tool for spray tips of agricultural sprayers.

Agricultural sprayers typically have quick-change nozzles. The caps tend to retain debris and must often be cleaned. Even though they are designed to be relatively quickly changed, the nozzles are often very difficult to remove, especially with protective gloves. Furthermore, agricultural sprayers include a significant number of such nozzles resulting in laborious and time-consuming maintenance.

### SUMMARY

A tool for agricultural sprayers having quick change nozzles according to one disclosed non-limiting embodiment of the present disclosure includes an elongated member defined along an axis; and a first pair of opposing slots to receive wings of an agricultural sprayer nozzle, the first pair of opposing slots defined within a plane that includes the axis.

A further embodiment of any of the foregoing embodiments of the present disclosure includes that a second pair of opposing slots at an end of the elongated member opposite that of the first pair of opposing slots.

A further embodiment of any of the foregoing embodiments of the present disclosure includes that the second pair of opposing slots comprises a width different than a width of the first pair of opposing slots.

A further embodiment of any of the foregoing embodiments of the present disclosure includes that a multiple of ribs that extend from an elongated member, the multiple of ribs parallel to the axis.

A further embodiment of any of the foregoing embodiments of the present disclosure includes that the tool is manufactured of a non-metallic material.

A further embodiment of any of the foregoing embodiments of the present disclosure includes that the tool is additively manufactured.

A further embodiment of any of the foregoing embodiments of the present disclosure includes that the tool is formed as sheets of material that wrap around axis.

A method of changing a quick-change nozzle of an agricultural sprayer, according to one disclosed non-limiting embodiment of the present disclosure includes installing a tool having a pair of opposing slots onto a set of wings of a quick-change nozzle of an agricultural sprayer; and rotating the tool by hand.

A further embodiment of any of the foregoing embodiments of the present disclosure includes that the rotating comprises rotating about an axis.

The foregoing features and elements may be combined in various combinations without exclusivity, unless expressly indicated otherwise. These features and elements as well as the operation thereof will become more apparent in light of the following description and the accompanying drawings. It should be appreciated however that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a perspective view of a tool according to one disclosed non-limiting embodiment.

FIG. 2 is a partial perspective view of an agricultural sprayer having multiple quick-change nozzles which may be changed with the tool of FIG. 1.

FIG. 3 is an end view of the tool of FIG. 1.

### DETAILED DESCRIPTION

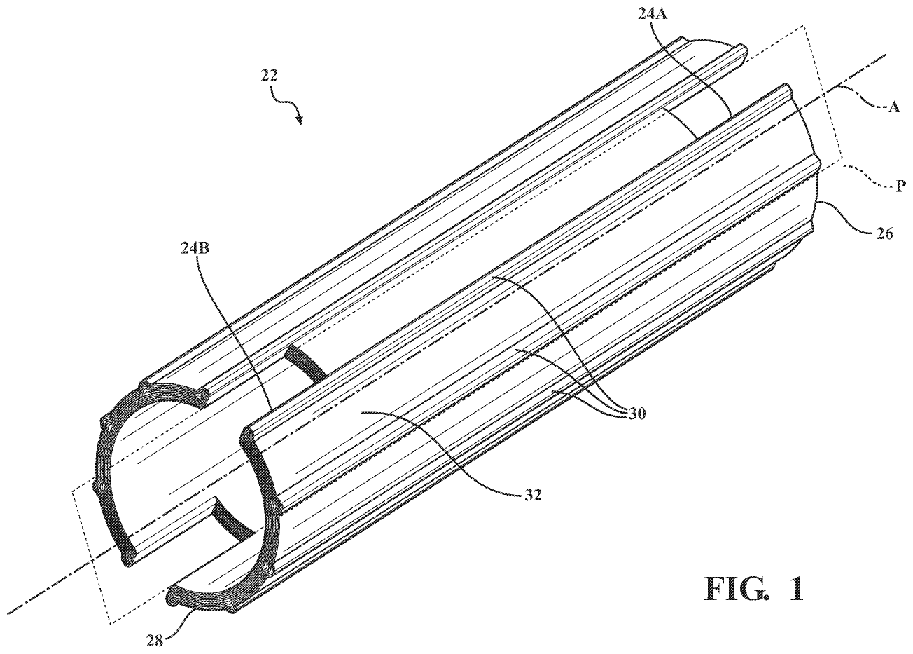

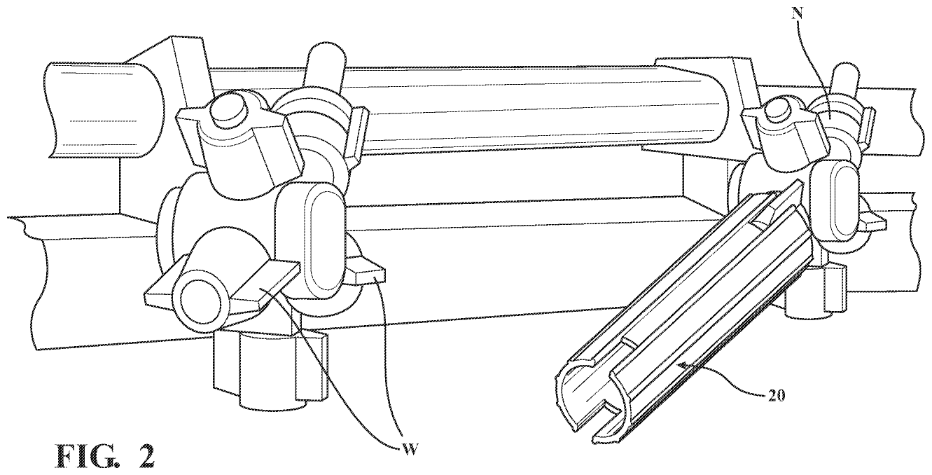

FIG. 1 schematically illustrates a tool 20 for agricultural sprayers having quick change nozzles N (FIG. 2). The tool 20 includes a generally elongated member 22 with a pair of opposing slots 24A, 24B adjacent each end 26, 28. The generally elongated member 22 is defined along an axis A, and may be tubular, cylindrical, hexagonal, octagonal, etc., in cross-section. In one embodiment, the opposing slots 24A, 24B are defined within a plane P that contains axis A.

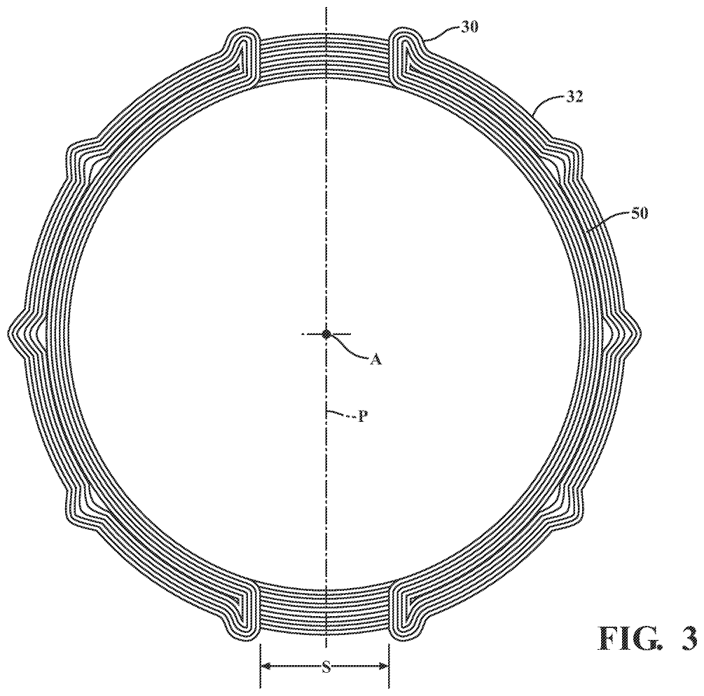

The opposing slots 24A, 24B may be of a similar or different width S (FIG. 3) so as to receive the winged quick change or ¼ turn nozzles N that includes wings W which may be of various sizes (FIG. 2). The wings W are otherwise designed to grasp with fingers so as to facilitate manual rotation with the hand. That is, the nozzles N are configured to be turned by hand, but are more rapidly and efficiently removed and/or replaced though the use of the tool 20 in which the slots engage the wings W of the nozzles N.

To facilitate a grip on the tool 20, a multiple of ribs 30 are located along the length of an external surface 32 of the generally elongated member 22. The ribs 30 may be parallel to the axis A.

In another disclosed embodiment, the tool 20 may be additively manufactured such that although various components are identified and described separately, such components may be manufactured in a unitary manner via additive manufacturing. It should be appreciated that, as defined herein, “additive manufacturing” processes include, but are not limited to, include stereolithography (SLA), selective laser sintering (SLS), fused deposition modeling (FDM), digital light process (DLP), and others. Although particular additive manufacturing processes are disclosed, those skilled in the art of manufacturing will recognize that any other suitable rapid manufacturing methods using layer-by-layer construction or additive fabrication can alternatively be used.

The additive manufacturing process fabricates or “grows” components using three-dimensional information, for example a three-dimensional computer model. The three-dimensional information is converted into a plurality of slices, each slice defining a cross section of the component for a predetermined height of the slice. The additive manufactured component is essentially “grown” slice-by-slice, or layer-by-layer, until finished. Each layer has an example size between about 0.0005-0.001 inches (0.0127-0.0254 mm). The additive manufacturing process facilitates manufacture of the relatively complex internal passage geometry to minimize assembly details, gun-drilling, and multi-component construction.

In another disclosed embodiment, the tool 20 may be formed as sheets 50 of material that wrap around axis A top thereby forming the generally elongated member 22 and the ribs 30 (FIG. 3). In other words, the sheets 50 are essentially rolled around the axis A during the additive manufacturing process. Such a structure facilitates resistance to the torque that is applied during use.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A tool for agricultural sprayers having quick change nozzles, comprising:
an elongated member defined along an axis; and
a first pair of opposing slots to receive wings of an agricultural sprayer nozzle, the first pair of opposing slots defined within a plane that includes the axis.

2. The tool as recited in claim 1, further comprising a second pair of opposing slots at an end of the elongated member opposite that of the first pair of opposing slots.

3. The tool as recited in claim 2, wherein the second pair of opposing slots comprises a width different than a width of the first pair of opposing slots.

4. The tool as recited in claim 1, further comprising a multiple of ribs that extend from an elongated member, the multiple of ribs parallel to the axis.

5. The tool as recited in claim 1, wherein the tool is manufactured of a non-metallic material.

6. The tool as recited in claim 5, wherein the tool is additively manufactured.

7. The tool as recited in claim 6, wherein the tool is formed as sheets of material that wrap around axis.

8. A method of changing a quick-change nozzle of an agricultural sprayer, comprising:
installing a tool having a pair of opposing slots onto a set of wings of a quick-change nozzle of an agricultural sprayer; and
rotating the tool by hand.

9. The method as recited in claim 7, wherein the rotating comprises rotating about an axis defined along the length of the tool.
